(19) United States
(12) Patent Application Publication
(10) Pub. No.: US 2026/0280728 A1
(43) Pub. Date: Sep. 17, 2026

(54) PHASE CALIBRATION OF RADIO-FREQUENCY FED ANTENNA ARRAYS

(71) Applicant: Sony Group Corporation, Tokyo (JP)

(72) Inventors: Fredrik RUSEK, Eslöv (SE); Erik BENGTSSON, Eslöv (SE); Jose FLORDELIS, Lund (SE)

(21) Appl. No.: 19/165,128

(22) PCT Filed: Mar. 25, 2024
(86) PCT No.: PCT/EP2024/057938

§ 371 Date: Sep. 14, 2025

(30) Foreign Application Priority Data
Mar. 31, 2023 (SE) 2350384-0

(51) Int. Cl. H04B 17/12; H01Q 3/26; H04B 17/21

(52) U.S. Cl. CPC H04B 17/12; H01Q 3/267; H04B 17/221

(57) ABSTRACT

Various examples relate to phase calibration measurements for calibrating an access node.

### TECHNICAL FIELD

Examples relate to communication in a communication network, wherein the communication network comprises an access node and a wireless communication device.

### BACKGROUND

Li, Qingchao, et al. “Reconfigurable Intelligent Surface Aided Amplitude-and Phase-Modulated Downlink Transmission.” arXiv preprint arXiv:2301.09717 (2023) describe methods of operating an access node (AN), in particular a transmitting node, of a communication network. The AN comprises a reconfigurable intelligent surface (RIS). The RIS may be fed by an unmodulated carrier from a single RF signal generator. The access node may rely on a single RF chain and the information may be transmitted by appropriately configuring the reflection coefficients of antenna elements of the RIS. In particular, the RIS may comprise an array of many antenna elements and the reflection coefficients may be configured by applying individual phase shifts to the antenna elements. The unmodulated carrier from the RF signal generator may then be reflected towards a specific direction, i.e. towards a specific wireless communication device (e.g., a user equipment, UE), with a beamforming gain that depends on the phase shifts.

Inaccurate knowledge of the location of the wireless communication device, e.g., of the direction and/or orientation of the wireless communication device, with respect to the AN may lead to inefficient data transmission from the AN to the UE.

### SUMMARY

Thus, there may be a need for improving signal transmission from an access node to a wireless communication device.

Said need has been addressed with the subject matter of the independent claims. Advantageous embodiments are described in the dependent claims.

Examples disclosed include a method performed by a wireless communication device. The wireless communication device is part of a communication network. The wireless communication device obtains a message. For instance, the message may be obtained from an access node of the communication network. The message requires characterization of phases of multiple pilot signals transmitted by the access node. Typically, the access node transmits the multiple pilot signals at multiple transmit amplitudes.

The method also includes receiving pilot signals from the access node. For instance, a sequence of pilot signals can be received. For instance, a burst of multiple pilot signals can be received.

Using the pilot signals, the access node can probe the impact of different settings of an array of antenna elements at the access node onto the phase of signals received at the wireless communication device. In particular, nonlinearities of the phase as a function of the number of activated antenna elements of the array can be probed.

The method also includes providing a message that is indicative of a receive property of the pilot signals to the access node. For instance, the wireless communication device can report, for each received pilot signal, the respective phase. It would also be possible that the wireless communication device combines receive properties of multiple received pilot signals into an indicator that is indicative of the characterization of the phases and then provides the indicator. Such reporting may be to the access node or to another entity, e.g., a control node associated with the access node.

Based on such reporting, it is possible to compensate for nonlinearities that can be specific to the particular location at which a wireless communication device is positioned when implementing a beamformed transmission—e.g., receive beamforming and/or transmit beamforming—at the access node. In particular, changes of the phase due to different numbers of activated antenna elements can be reduced. The number of activated antenna elements can be changed from symbol to symbol transmitted or received at the access node. Thereby, an envelope function can be created, e.g., for Orthogonal Frequency Division Multiplex (OFDM) modulation.

The characterization of the phases can be implemented device-specific. I.e., different wireless communication devices (located at different positions in the surrounding of the access node) typically observe different phases.

Examples disclosed include a method performed by an access node of a communication network. The method includes providing, to a wireless communication device of the communication network, a message. This message is indicative of the access node requiring the wireless communication to characterize phases of multiple pilot signals. The method may be obtained from the wireless communication device. The message may be a control message, e.g., an Radio Resource Control (RRC) message provided to the wireless communication device. The message may be transmitted in a point-to-point manner, i.e., may be directed specifically to the wireless communication device rather than all recipients. It can be a unicast control message. Accordingly, the message may be device-specific for the wireless communication device.

The method also includes sequentially transmitting, to the wireless communication device, pilot signals. The multiple pilot signals can be transmitted at multiple transmit powers. The multiple transmit powers can be implemented be activating a certain number of antenna elements of a RIS of the access node. The method also includes obtaining a message that is indicative of a receive property of the The method may further include applying a calibration when performing a multi-antenna transmission (e.g., beamforming or generally a multi-input multi-output transmission) towards the wireless communication device based on the message. The transmission can include a downlink and/or an uplink transmission.

The multi-antenna transmission is performed using reflection coefficients set at a reflective intelligent surfaces of the access node. The reflection coefficients can be adjusted from OFDM symbol to OFDM symbol based on the calibration. Thereby, an envelope of a modulation can be shaped. Also single carrier modulation would be possible, e.g., amplitude phase shift keying. Such adjustment of the reflection coefficient can be implemented by precoding the signal that modulates the configuration of the antenna elements of the RIS.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication network comprising an AN and a UE;

FIG. 2 schematically illustrates amplitude over active antenna elements;

FIG. 3 schematically illustrates phase over active antenna elements;

FIG. 4 schematically illustrates phase over active antenna elements in case of direction inaccuracies; and

FIG. 5 is a signaling diagram.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by an access node (AN), in particular, a base station (BS), of the RAN, and the one or more receiver nodes can be implemented by wireless communication devices (also referred to as user equipment, UE). It would also be possible that the transmitter node is implemented by a UE and the one or more receiver nodes are implemented by an AN and/or further UEs. Hereinafter, for the sake of simplicity, various examples will be described with respect to an example implementation of the transmitter node by one or more ANs and the one or more receiver node by UEs—i.e., to downlink (DL) communication; but the respective techniques can be applied to other scenarios.

Hereinafter, techniques that employ a RIS-based access node are disclosed. The RIS can be implemented as a parabolic antenna. An RF source us provided that transmits the RF signal to the parabolic antenna. The parabolic antenna includes an array of antenna elements. The distance between the feeder and the antenna is small and in the near-field of the electromagnetic waves. The antenna elements can be quickly switched, e.g., using a barium-strontium-titanate technology.

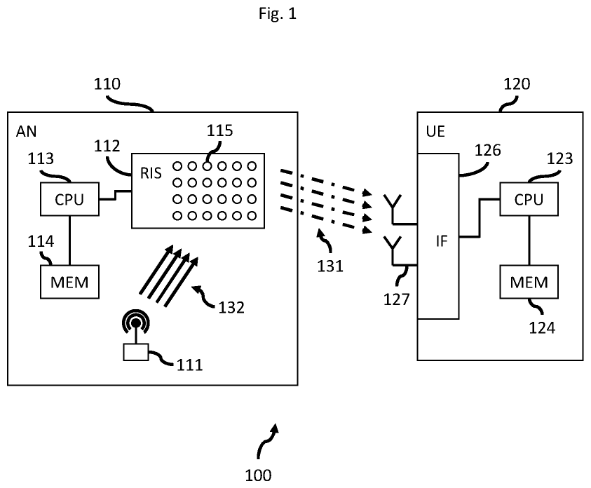

FIG. 1 illustrates a communication network 100 comprising an access node (AN) 110 and a wireless communication node (UE) 120. The AN 110 comprises an RF signal generator 111, a RIS 112 and control circuitry for controlling the RIS 112 and/or the RF signal generator 111. The RF signal generator 111 is fed by a single RF chain, i.e., using a single digital-to-analog converter. The control circuitry may be implemented by a processor 113 and a non-volatile memory 114. The processor 113 can load program code that is stored in the memory 114. The processor 113 can then execute the program code. Executing the program code causes the processor to perform techniques as described herein. The UE 120 includes control circuitry that is implemented by a processor 123 and a non-volatile memory 124. The control circuitry 123, 124 may control an interface 126 connected to antennas 127. The processor 123 can load program code that is stored in the memory 124. The processor 123 can execute the program code. Executing the program code causes the processor 123 to perform techniques as described herein.

The energy for the signal 131 to be transmitted from the AN 110 to the UE 120 is provided by the RF signal generator 111 transmitting an unmodulated carrier signal 132. Thus, there is a radio transmission within the AN 110, from the RF signal generator 111 to the RIS 112. The RS signal generator 111 is typically arranged in the electromagnetic near field of the RIS 112.

In some examples, the AN 110 may not include the RF signal generator 111 itself, but the unmodulated carrier 132 used by the AN 110 may be provided by other means. Control circuitry 113, 114 of the AN 110 may control antenna elements 115 of the RIS 112 to generate the signal 131, which may be an orthogonal frequency-division multiplexing (OFDM) signal 131. In contrast to legacy procedures, an antenna is not fed with the OFDM signal to be transmitted but the RIS 112 merely modifies an unmodulated carrier 132. This may avoid peak-to-average power ratio (PAPR) related issues as will be explained hereinafter.

A complex baseband OFDM signal s(t) may have to be transmitted towards a direction k, wherein k=[kₓ k_{y}] is a 2×1 vector, subject to the constraint k^{T}k≤1, which is also known as a directional cosine being fully equivalent to a direction in a spherical coordinate system. Then, a standard implementation would be to amplify and up-convert signal s(t), yielding z(t)=\sqrt{P} [symbol] {s(t)e^{iω}^{_{c}}^{t}}, where [symbol] {⋅} is the real part of the argument, ω_{c} is the carrier frequency, and P a measure of the transmit power. The signal z(t) is then split and fed to each antenna element 115. Each antenna element 115 applies a unique phase shift (this defines the reflection coefficients). That is, the transmitted signal from antenna element k reads z(t−Tₖ)/U, where U is a power reduction due to the split of the signal z(t), and Tₖ is a time delay that ultimately translates into a phase shift of the signal s(t) at the receiver side, i.e. at the wireless communication device.

Taken together, the phase shifts/reflection coefficients across the entire array of antenna elements beamform the signal s(t) towards the direction k. Typically, the signal s(t), due to its OFDM nature, has a large dynamic range. Therefore, power amplifiers having a linear characteristic across a large range are required. Implementing power amplifiers having a linear characteristic across the required large range is very difficult. Usually a power back-off is applied as a remedy. However, this back-off translates to a pure loss of energy and may have to be dissipated in the form of heat.

In a scenario as depicted in FIG. 1, power amplification is performed by the RF signal generator 111 on an unmodulated carrier, i.e. a constant envelope signal. Hence, it is no longer required to have a power amplifier having a linear characteristic across a large range. The amplitude variations required for transmitting the OFDM signal s(t) may be created by controlling the number of active antenna elements in the array. In other words, it is possible to vary—from OFDM symbol to OFDM symbol—the number of active antenna elements.

Considering an array of N×L antenna elements 115, each antenna element 115 may be configured with a time delay that corresponds to a phase [symbol] = [symbol] +φ, where [symbol] is beamforming dependent, and φ is common to all antenna elements 115 and represent the phase of the data signal s(t). Optionally, each antenna element 115 may be switched on or off via a control signal [symbol] ∈{0,1}. In some scenarios, as an alternative to switching off, the beamforming-dependent phase value [symbol] may be set to a random value. Selecting random values may achieve essentially the same effects as switching off antenna elements 115 and a respective hardware implementation may be simpler.

Assuming a rectangular array of N×L antenna elements 115 and the far field, at complex baseband, the transmitted signal x(t) in direction k reads

$$x ( t ) = {e}^{i φ ( t )} {\sum }_{n , ℓ} {a}_{n , ℓ} ( t ) {e}^{i {θ}_{n , ℓ}} {e}^{- i ( {k}_{x} n + {k}_{y} ℓ )} .$$

As shown in the above equation, the antenna configuration, i.e. [symbol] (t), is time dependent. Selecting the beamforming-dependent part [symbol] as [symbol] =kₓn+k_{y} [symbol] results in

$$x ( t ) = {e}^{i φ ( t )} {\sum }_{n , ℓ} {a}_{n , ℓ} ( t ) .$$

If N and L are large, x(t) may be considered a quantized version of s(t). Said quantization comprising NL equidistant amplitude levels, and physically represented by the number of elements that are active, i.e., the number of values [symbol] (t) that equal one. Provided that [symbol] =kₓn+k_{y} [symbol] , x(t) only depends on the number of active antenna elements 115 and not on the actually selected specific antenna elements 115.

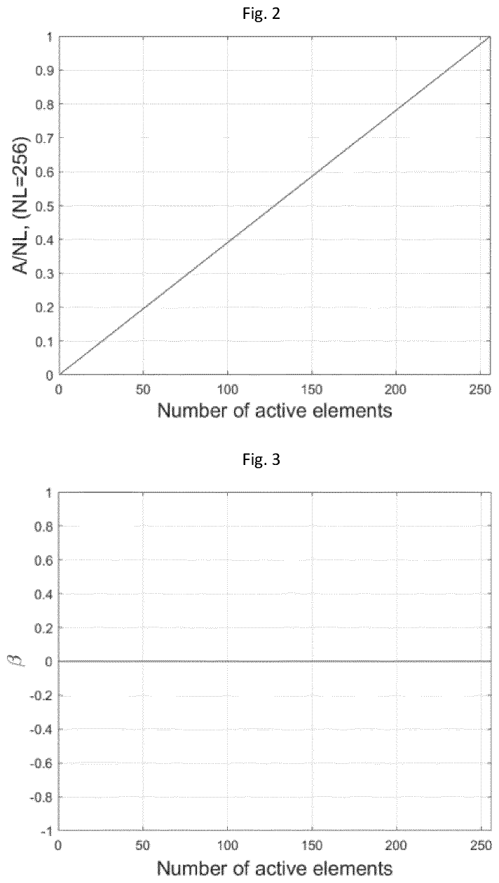

x(t) may be decomposed in polar form as x(t)=A(t)e^{iβ(t)} with A(t)= [symbol] [symbol] (t)≥0 and β(t)=φ(t). Thus, the RIS at the AN could be seen as a perfect amplifier. To illustrate this further, the amplitude A and phase β may be plotted as functions of the number of active antenna elements 115 in FIGS. 2 and 3, i.e., [symbol] [symbol] wherein the time-dependency on A and β is not shown. The amplitude is normalized to the number NL=256 of antenna elements 115 and the phase φ has been chosen as φ=0. As shown in FIG. 2, the RIS of the AN could be considered as a perfectly linear amplifier.

However, [symbol] has been assumed to read [symbol] =kₓn+k_{y} [symbol] . This only holds true if the direction towards the UE 120 is perfectly known. In practice, [symbol] may have to be constructed from an estimate \hat{k}=k+e resulting in

$$x ( t ) = {e}^{i φ ( t )} {\sum }_{n , ℓ} {e}^{i ( {\hat{k}}_{x} n + {\hat{k}}_{y} ℓ )} {e}^{- i ( {k}_{x} n + {k}_{y} ℓ )} = {e}^{i φ ( t )} {\sum }_{n , ℓ} {a}_{n , ℓ} ( t ) {e}^{i ( {e}_{x} n + {e}_{y} ℓ )} .$$

Considering IJ activated antenna elements 115 in a corner of the RIS 112, x(t) may be written as

$$x ( t ) = {e}^{i φ ( t )} {\sum }_{n = 1 , ℓ = 1}^{I , J} {a}_{n , ℓ} ( t ) {e}^{i ( {e}_{x} n + {e}_{y} ℓ )} = {e}^{i φ ( t )} {e}^{i ( {e}_{x} ( I + 1 ) + {e}_{y} ( J + 1 ) ) / 2} \frac{sin ( \frac{{e}_{x} I}{2} )}{sin ( \frac{{e}_{x}}{2} )} \frac{sin ( \frac{{e}_{y} J}{2} )}{sin ( \frac{{e}_{y}}{2} )} .$$

For small values of eₓ and e_{y}, sin

$$( \frac{{e}_{x} I}{2} ) \approx \frac{{e}_{x} I}{2} and sin ( \frac{{e}_{y} J}{2} ) \approx \frac{{e}_{y} J}{2}$$

applies resulting in

$$x ( t ) \approx {e}^{i φ ( t )} {e}^{i ( {e}_{x} ( I + 1 ) + {e}_{y} ( J + 1 ) ) / 2} IJ .$$

This may be considered a linear amplification, since the amplitude IJ coincides with the number of active antenna elements 115.

Linear amplification is only lost when

$$\frac{{e}_{x} I}{2} or \frac{{e}_{y} J}{2}$$

can no longer be considered a reasonable approximation for sin

$$( \frac{{e}_{x} I}{2} ) or sin ( \frac{{e}_{y} J}{2} ) ,$$

respectively.

However, phase stability is lost much quicker than linear amplification, as the received phase is given by

$$\frac{{e}_{x} ( I + 1 ) + {e}_{y} ( J + 1 )}{2} .$$

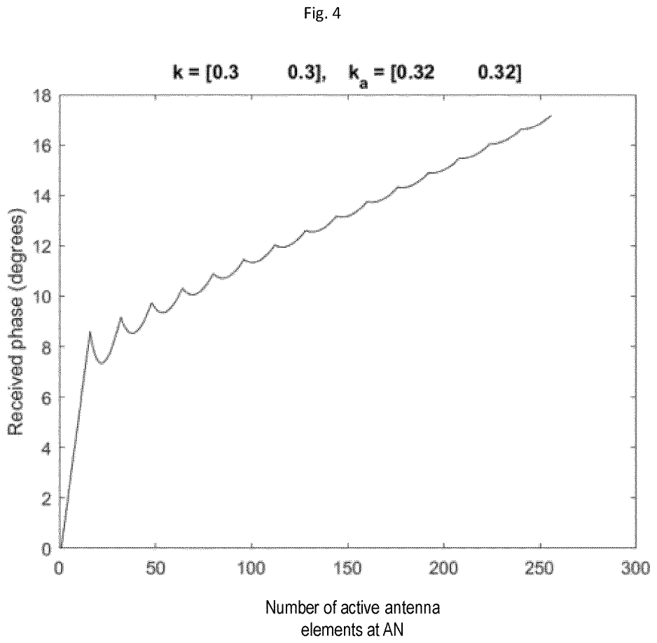

FIG. 4 illustrates a scenario, in which an increasing number of up to NL=256 antenna elements of a quadratic array (N,L=16) is activated, for k=[0.3 0.3] and \hat{k}=[0.3 0.32].

Hence, the AN may require wireless communication devices that are served to report on the phase variations induced by the number of activated antenna elements at the AN. I.e., a characterization of the phases of reference signals transmitted at different transmit powers may be requested. These phase variations can vary from wireless communication device to wireless communication device such that the reporting is specific to the wireless communication device. Different wireless communication devices may be individually requested to provide the characterization of the phases at the respective location.

The AN 110 may transmit pilot signals 131, on which the UE 120 measures and reports. The multiple pilot signals 131 have different amplitudes. In some scenarios, the AN 110 may use pilot signals 131 as already defined in a standard defined by the Third Generation Partnership Project (3GPP). For example, the AN 110 may transmit channel state information reference signals (CSI-RS). Pilot signals have a well-defined timing and time-frequency position. They are transmitted using an a-priori known pilot signal shape so that it is possible to probe the radio channel or here specifically the impact of switching antenna elements on/off by comparing a receive property with the pilot signal shape. For instance, multiple pilot signals can be included in an OFDM symbol.

The UE 120 measurements are typically done in the frequency domain. However, characterization of phases requires time-domain measurements (since antenna elements are sequentially activated or deactivated in-between transmission of pilot signals). More precisely, the UE 120 receives the pilot signals 131 which may (after removal of the cyclic prefix) be denoted in the time domain as yₙ. These pilot signals 131 may be expressed as

$${y}_{n} = h {*}_{c} D ( \vert {r}_{n} \vert ) {r}_{n} + {w}_{n} ,$$

wherein “*_{c}” denotes circular convolution, h is the impulse response of the radio channel between the AN 110 and the UE 120, which may be largely assumed to be close to a delta function, rₙ is the n:th vector including multiple pilot signals of different amplitudes (e.g., a pilot signal burst or a 3GPP reference signal), and wₙ is noise, |rₙ| is a vector of the same dimension as rₙ but where each element has been replaced with its magnitude. Depending on the number of pilot signals included in rₙ, it may suffice to set n=1. The operator D(⋅) can be represented by a diagonal matrix, defined from its vector-valued argument, that represents the phase and amplitude non-linearity; wherein the k:th diagonal element D, where from now on the dependency on rₙ is not explicitly indicated, depends on the amplitude of the k:th element in rₙ, i.e., the k:th element of |rₙ|. According to examples, the functional form of the operator D(⋅) is to be determined, to compensate for phase instabilities/nonlinearities at the AN 110 for various amplitudes. Thus, the objective of the measurements at the UE is to determine the functional form of said dependency. The multiple pilot signals are first used to estimate h. The channel h is not a-priori known. Thus, to estimate the channel h, one option is to select (e.g., randomly) multiple pilot signals and then perform, for each selected pilot signal, a standard channel estimation (e.g., matrix inversion) using these pilot signals. This initial estimate ignores the phase instabilities/nonlinearities introduced at the RIS (that are also unknown at this point). The results can then be averaged. It has been found that this works well for an initial estimate of the channel h that is then used to determine the calibration, as explained next. The next step is to recreate the signals h*_{c}rₙ. These can now be compared with the received signals yₙ to obtain D. The functional form of D may be derived by calculating the phase and amplitude in T bins, i.e., at T levels with different amplitude in rₙ. D may than be used for calibration at the AN 110; it quantifies the phase distortions captured by the pilot signals. It would also be possible to refine the initial estimate of the channel h based on the knowledge of the phase instabilities/nonlinearities at the RIS (i.e., based on the phase distortions); and then use this refined estimate of the channel h to again determine a better estimate for D. This corresponds to an iterative calculation. The calculations may be performed by the UE 120 or the AN 110. In case the UE 120 performs the calculations. Performing the calculations by the UE 120 may require less time-frequency resources for transmitting the characterization of phases from the UE 120 to the AN 110. On the other hand, the AN 110 may have more computing resources available for deriving D.

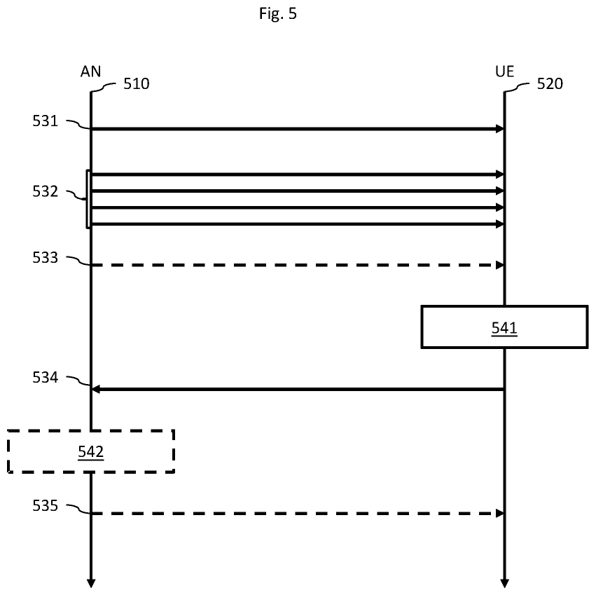

FIG. 5 is a signaling diagram illustrating signaling between an AN 510 and a UE 520 of a communication network.

The UE 520 obtains a message 531 indicative of the AN 510 requiring the UE 520 to provide a characterization of phases of sequential pilot signals. This characterization is specific to the UE 520; other UEs (not shown in FIG. 5) may be likewise requested to provide the characterization of phases of sequential pilot signals. In the example of FIG. 5, the AN 501 provides the message 531 to the UE 520. However, it also conceivable that the UE 520 obtains the message 531 from another node of the communication network.

The access node 510 transmits the pilot signals. The access node 510 transmits the pilot signals using the RIS 112. The pilot signals are transmitted using transmit beamforming towards the UE. The pilot signals are transmitted using different settings for the number of activated antenna elements. Thereby, different OFDM symbols or more generally different amplitude levels of a modulation can be mimicked. Different gains can be probed. In-between transmitting two subsequent pilot signals, the number of activated antenna elements is changed. This may require some time at the AN 510.

The UE 520 then receives, from the AN 510, pilot signals 532. The pilot signals 532 may be implemented by one or more channel state information reference signals (CSI-RS) or some other appropriate type of reference signal. The pilot signals can be implemented by one or more 3GPP-specified reference signals.

The UE 520 measures 541 on the pilot signals 532. In particular, the UE 520 may perform measurements in the time domain.

The pilot signals 532 are transmitted sequentially, e.g., with a certain time offset. For instance, a burst of pilot signals 532 may be transmitted. In between transmitting each of the pilot signals 532, the AN 501 changes the number of activated antenna elements.

In some examples, pilot signals are repeatedly transmitted, e.g., at a fixed repetition rate. The repetition rate can be set depending on the coherence time of the channel.

The pilot signals 532 may be transmitted as part of a waveform, not necessarily an OFDM waveform. For example, data samples could be grouped into frames. A frame could have a training field and a data bearing field. Then, the pilot signals 532 could be part of, or constitute, the training field. A training field would in general not be needed every frame, depending on the coherence time of the channel. An OFDM symbol can also be a frame. In that case, a whole OFDM symbol could be made up of pilot signals.

The UE 520 may obtain a channel estimate of the radio channel between the AN 510 and the UE 520. Obtaining a channel estimate may comprise deriving the channel estimate from the pilot signals 532. In some scenarios, obtaining a channel estimate may comprise obtaining, in particular from the AN 510, a message 533 indicative of the channel estimate.

The UE 520 provides a message 534 indicative of a receive property of the pilot signals. The UE 520 may provide the message 534 to the AN 510.

The receive property may be indicative of phase distortions of the pilot signals 532, in particular the receive property may be indicative of amplitude induced phase distortions of the pilot signals 532. As explained hereinbefore, transmissions from access nodes comprising a RIS and using it for transmitting OFDM signals may suffer from amplitude induced phase distortions.

The phase distortions pertain to deviation from the transmitted/configured phase at the AN and the received phase at the UE for a memoryless channel that may be represented as a pure Dirac delta function. The deviation may be dependent on the transmitted/configured amplitude at the AN. This is explained in further detail below. Consider that a signal having a certain amplitude A and a certain phase p is to be transmitted to the receiver. Therefore, the RIS is configured with a number of active antenna elements; the number of active elements is proportional to the amplitude A. Also, all active antenna elements will apply the phase p. In addition, there is an element-dependent beamforming phase configured for each antenna element. If the beamforming phases were perfect, which means that the spatial direction towards the UE is perfectly known, then the UE would observe the phase p, and an amplitude that is proportional to A. However, since the beam in any practical scenario is not exactly pointing towards the UE, the phase will not be p at the UE. The amplitude will be A (almost exactly), but the phase is more sensitive. In fact, the phase will be p+D(A), where the functional relationship of D( ) is a-priori unknown and determined based on the pilot signals. Pilot signals with known amplitudes are sequentially transmitted (over time), say r₁=[1 2 3 4 5]. Without a multipath channel, the receiver at the UE would observe amplitudes [1 2 3 4 5] and some phases [10 20 5 35 15] deg. In the absence of phase problems (i.e., no misalignment of the beam), the phase vector would simply be [0 0 0 0 0]. In such idealized scenario D can be directly derived. D(r₁) is a diagonal matrix with complex exponentials of these phases. If the amplitude is 1, then the 10 deg phase is added. If the amplitude is 4, then 35 deg phase is added. However, this procedure is complicated for a realistic scenario where a multipath channel is present. For instance, if the sequence of pilot signals [1 2 3 4 5] is transmitted, the receiver at the UE receives convolution of this [1 2 3 4 5] with an a-priori unknown channel h. Maybe, the UE receives the following amplitudes [8 −1 2 −5 7] and phases [−10 89 65 20]. But the problem is that the phase distortion is added based on the transmitted amplitudes [1 2 3 4 5], not on the received ones. That is, the phases [−10 89 65 20] mean nothing without the knowledge of the channel. Thus, first (i) the channel is determined, then second (ii) the channel is removed from the amplitudes, and then third (iii) the phases are read. Here, the amplitude removal in step (ii) alters the phases and it is necessary to find D( ) based on the phases after removing h. But finding h is cumbersome since the transmitted ref signal has been affected by D( ) in an unknown way. But doing conventional channel estimation many times and averaging the result gives an accurate estimate of h. It is then possible remove h from the received signal, and removing it reveals the signal amps [1 2 3 4 5] and amplitude-dependent phase distortions [10 20 5 35 15].

The message 534 indicative of a receive property of the pilot signals 532 may be indicative of a receive property of the pilot signals 532 may be indicative of calibration parameters to be used when transmitting. For example, the message 534 may be indicative of one or more matrices D. In other scenarios, the AN 510 may derive 542 the calibration parameters to be used when transmitting from the message 534. For example, the AN 510 may derive 542 the one or more matrices D matrices from a message 534 indicating yₙ.

Accordingly, a set of different calibration parameters—corresponding to D—is obtained. Each calibration parameter of the set is associated with a respective number of activated antenna elements at the AN 510. The AN 510 then—depending on the number of activated antenna elements—selects the appropriate calibration parameter/matrix—from the set when transmitting signals, to compensate for nonlinearities.

Thus, finally, the AN 510 may use the calibration parameters to transmit signals 535 transmitting data or control information to the UE 520. The AN configures all activated antenna elements with the intended information bearing phase minus the phase-contribution due to the directional misalignment for this particular number of activated antennas. Said phase contribution being given by the phase of D( [symbol] [symbol] (t)). Alternatively or additionally, it is also possible to change the phase of the unmodulated carrier transmitted by the RF source.

In further detail: The D matrix implies that if one seeks to communicate the phase φ(t), then the received phase β(t) becomes

$$exp ( i β ( t ) ) = exp ( i φ ( t ) ) D ( {\sum }_{n , ℓ} , {a}_{n , ℓ} ( t ) ) ,$$

where D is now a scalar values since the argument is scalar.

To make sure that the received phase is indeed φ(t), it is necessary to transmit a phase

$${φ}_{sent} ( t ) = φ ( t ) - arg ( D ( {\sum }_{n , ℓ} {a}_{n , ℓ} ( t ) ) ) ,$$

Where “arg” is the phase of a scalar number.

Plugging in this transmitted phase, the received signal is

$$exp ( i β ( t ) ) = exp ( i {φ}_{sent} ( t ) ) D ( {\sum }_{n , ℓ} {a}_{n , ℓ} ( t ) ) = exp ( i φ ( t ) ) {D}^{- 1} ( {\sum }_{n , ℓ} {a}_{n , ℓ} ( t ) ) D ( {\sum }_{n , ℓ} {a}_{n , ℓ} ( t ) ) = exp ( i φ ( t ) )$$

So, in plain language: The AN should change the phase of all antenna elements and/or change the instantaneous phase of the unmodulated carrier.

Alternatively or additionally, it is also possible—assuming channel reciprocity—to use the calibration parameters to receive signals from the UE. The access node 510 performs beamforming to transmit data to the UE and/or receive data from the UE. The beamforming is performed by setting reflection coefficients at the antenna elements of the RIS. The number of activated antenna elements at the RIS is adjusted along with changing symbols of the respective modulation. Along with a change of the number of active antenna elements, also the calibration is adjusted. I.e., different calibration parameters are selected from a corresponding set depending on the number of active antenna elements.

Summarizing, at least the following EXAMPLES have been described above:
EXAMPLE 1. A method performed by an access node (510) of a communication network, the method comprising:
   providing, to a wireless communication device of the communication network, a message (531) indicative of the access node (510) requiring characterization of phases of multiple pilot signals sequentially transmitted by the access node (510);
   sequentially transmitting, to the wireless communication device, the multiple pilot signals (532); and
   obtaining an indication of one or more receive properties of the multiple pilot signals (532).
EXAMPLE 2. The method of EXAMPLE 1,
   wherein the one or more receive properties are indicative of amplitude-induced phase distortions of the pilot signals (532).
EXAMPLE 3. The method of EXAMPLE 1 or 2,
   wherein the message (531) provided to the wireless communication device is indicative of the access node requiring at least one of a location-specific characterization or a wireless-communication-device-specific characterization of the phases of the multiple pilot signal.
EXAMPLE 4. The method of any one of the preceding EXAMPLEs,
   wherein the multiple pilot signals (532) are transmitted at multiple transmit amplitudes.
EXAMPLE 5. The method of EXAMPLE 4, further comprising:
   switching on or off antenna elements of a reflective intelligent surface of the access node (510) to implement the multiple transmit amplitudes.
EXAMPLE 6. The method of any one of the preceding EXAMPLEs,
   wherein the multiple pilot signals are part of one or more sequential Orthogonal Frequency Division Multiplex, OFDM, symbols.
EXAMPLE 7. The method of any one of the preceding EXAMPLEs,
   wherein the message provided to the wireless communication device is a unicast message.
EXAMPLE 8. The method of any one of the preceding EXAMPLEs, further comprising:
   determining a channel estimate of the radio channel between the access node and the wireless communication device based on an average associated with the one or more receive properties of the multiple pilot signals.
EXAMPLE 9. The method of EXAMPLE 8, further comprising:
   based on phase distortions of the pilot signals (532), refining the channel estimate of the radio channel determined based on the average.
EXAMPLE 10. The method of any one of the preceding EXAMPLEs, further comprising:
   based on the indication of one or more receive properties of the pilot signals (532), applying a calibration when performing a multi-antenna transmission towards the wireless communication device,
   wherein the calibration is adjusted from modulation symbol to modulation symbol of the multi-antenna transmission.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above scenarios have been disclosed in which a passive RIS is used by the access node. Here, individual antenna elements are not capable of providing an antenna-element-specific gain. Individual antenna elements of the access node apply an antenna-element-specific phase shift. In variations, and active RIS is used by the access node; here, individual antenna elements apply reflection coefficients that are characterized by, both, an antenna-element-specific amplitude gain, as well as an antenna-specific phase shift.

1. A method performed by an access node of a communication network, the method comprising:
providing, to a wireless communication device of the communication network, a message indicative of the access node requiring characterization of phases of multiple pilot signals sequentially transmitted by the access node;
sequentially transmitting, to the wireless communication device, the multiple pilot signals; and
obtaining an indication of one or more receive properties of the multiple pilot signals.

2. The method of claim 1,
wherein the one or more receive properties are indicative of phase distortions of the pilot signals.

3. The method of claim 1,
wherein the one or more receive properties are indicative of amplitude-induced phase distortions of the pilot signals.

4. The method of claim 1,
wherein the message provided to the wireless communication device is indicative of the access node requiring at least one of a location-specific characterization or a wireless-communication-device-specific characterization of the phases of the multiple pilot signals.

5. The method of claim 1,
wherein the multiple pilot signals are transmitted at multiple transmit amplitudes.

6. The method of claim 5, further comprising:
switching on or off antenna elements of a reflective intelligent surface of the access node to implement the multiple transmit amplitudes.

7. The method of claim 1,
wherein the multiple pilot signals are part of one or more sequential Orthogonal Frequency Division Multiplex, OFDM, symbols.

8. The method of claim 1,
wherein the message provided to the wireless communication device is a unicast message.

9. The method of claim 1, further comprising:
providing, to the wireless communication device, a channel estimate of the radio channel between the access node and the wireless communication device.

10. The method of claim 1, further comprising:
determining a channel estimate of the radio channel between the access node and the wireless communication device based on an average associated with the one or more receive properties of the multiple pilot signals.

11. The method of claim 10, further comprising:
based on phase distortions of the multiple pilot signals, refining the channel estimate of the radio channel determined based on the average.

12. The method of claim 1, further comprising:
obtaining, from the wireless communication device, a message indicative of the one or more receive properties of the multiple pilot signals.

13. The method of claim 12,
wherein the message obtained from the wireless communication device is indicative of calibration parameters to be used when transmitting.

14. The method of claim 1, further comprising:
based on the indication of one or more receive properties of the multiple pilot signals, applying a calibration when performing a multi-antenna transmission towards the wireless communication device.

15. The method of claim 14,
wherein the multi-antenna transmission is a beamformed transmission.

16. The method of claim 14,
wherein the calibration is adjusted from modulation symbol to modulation symbol of the multi-antenna transmission.

17. The method of claim 14,
wherein the calibration is adjusted each time a number of active antenna elements of a reflective intelligent surface the access node is changed.

18. The method of claim 1, further comprising:
performing a multi-antenna beamforming transmission towards the wireless communication device by setting reflection coefficients at antenna elements of a reflective intelligent surface of the access node in accordance with the one or more receive properties.

19. A method performed by a wireless communication device of a communication network, the method comprising:
obtaining, from the communication network, a message indicative of an access node of the communication network requiring characterization of phases of multiple pilot signals sequentially transmitted by the access node;
receiving, from the access node, the multiple pilot signals; and
providing, to the communication network, a message indicative of one or more receive properties of the pilot signals.

20. The method of claim 19,
wherein the one or more receive properties are indicative of phase distortions of the pilot signals.

21-30. (canceled)
